(19) United States
(12) Patent Application Publication
(10) Pub. No.: US 2024/0178878 A1
(43) Pub. Date: May 30, 2024

(54) UPLINK-FREQUENCY HOPPING METHOD AND DEVICE

(71) Applicant: Nanning FuLian FuGui Precision Industrial Co., Ltd., Nanning (CN)

(72) Inventors: DAN FU, Nanning (CN); QING-ZHU WEI, Nanning (CN)

(21) Appl. No.: 18/244,476

(22) Filed: Sep. 11, 2023

(30) Foreign Application Priority Data
Nov. 24, 2022 (CN) 202211485302.3

(51) Int. Cl. H04B 1/7136

(52) U.S. Cl. CPC H04B 1/7136; H04B 2001/7154

(57) ABSTRACT

In an uplink frequency hopping method and device, whether the weather is bad is determined; when the weather is bad, rain attenuation is estimated according to a preset rainfall estimation model and a preset rainfall monitoring system; when the rain attenuation is not less than a first preset threshold, a variable factor is generated; and when the variable factor exists, an uplink frequency is adjusted according to a preset frequency hopping algorithm.

### CROSS-REFERENCE TO RELATED APPLICATIONS

This application claims priority to Chinese Patent Application No. 202211485302.3 filed on Nov. 24, 2022, in China State Intellectual Property Administration, the contents of which are incorporated by reference herein.

### FIELD

The subject matter herein generally relates to uplink-frequency hopping technology, in particular to an uplink-frequency hopping method and device.

### BACKGROUND

In order to improve the reliability of data transmission in 5G New Radio (NR) system, uplink frequency hopping provides one of the solutions. The frequency hopping mode is called Intra and Inter-subframe Hopping. Even and even time slots, odd and odd time slots between different subframes have the same physical resource block (PRB) position. There are many uncertainties which can cause interferences in the actual environment. Therefore, if the PRB image position is not regular, the frequency diversity effect will be better, so there will be intra-subframe and inter-subframe frequency hopping during actual allocation.

The PRB image position is relatively regular, but in certain circumstances, strong interferences may suddenly appear in the system, and the interference may happens near the allocated resource block (RB). If the system does not have other anti-interference measures in these circumstance, transmissions of uplink data will inevitably be affected. Therefore, it is necessary to optimize the existing frequency hopping method.

### BRIEF DESCRIPTION OF THE DRAWINGS

Implementations of the present technology will now be described, by way of example only, with reference to the attached figures, wherein:

FIG. 1 illustrates an exemplary embodiment of functional modules of an uplink-frequency hopping device according to the present disclosure;

FIG. 2 is a flowchart of an uplink-frequency hopping method according to an embodiment of the present disclosure; and

FIG. 3 is a frequency correlation coefficient table of a preferred embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

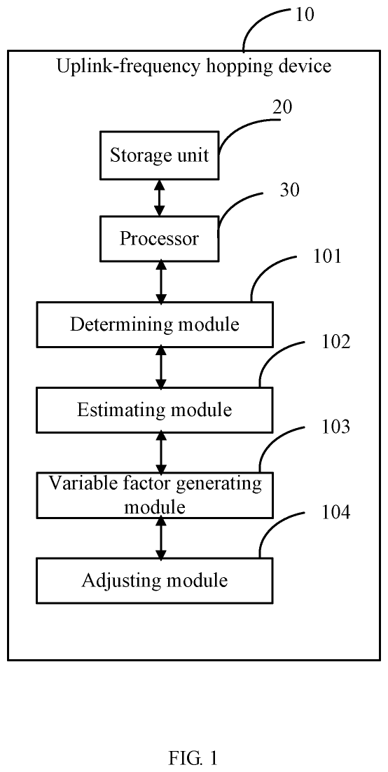

FIG. 1 illustrates an exemplary embodiment of functional modules of an uplink-frequency hopping device 10.

The uplink-frequency hopping device 10 includes a determining module 101, an estimating module 102, a variable factor generating module 103, and an adjusting module 104. The uplink-frequency hopping device 10 further includes a storage unit 20, and a processor 30. The modules are configured to be executed by one or more processors (in the embodiment, one processor 30). The modules referred to are computer program segments that perform specific instructions. The storage unit 20 is used to store program code and other data of the management system for a shared radio unit 10. The processor 30 is used to execute the program code stored in the storage unit 20.

The storage unit 20 includes at least one type of readable storage medium, the readable storage medium includes a flash memory, a hard disk, a multimedia card, a card-type memory (for example, SD or DX memory, etc.), a random access memory (RAM), a static random access memory (SRAM), a read only memory (ROM), an electrically erasable programmable read only memory (EEPROM), a programmable read only memory (PROM), a magnetic memory, a magnetic disk, an optical disk, and other components. The processor 30 may be a central processing unit (CPU), a controller, a microcontroller, a microprocessor, or other data processing chip.

The determining module 101 is configured to determine whether the weather is bad.

The determining module 101 determines whether there is at least one of heavy rain, heavy fog, and weather guided wave in current weather condition, if so, then the determining module 101 determines that the current weather condition is bad.

Bad weather will affect wireless communication, so 5G wireless networks will also be affected. Bad weather includes: heavy rain, heavy fog, and weather guided waves. The interference of such bad weather on wireless communication is called rain attenuation. In the planning of 5G wireless network, the margin of the rain attenuation, that is, the attenuation caused by radio waves entering the rain layer, will be considered. According to the actual measurement and statistics, the absorption attenuation of rain particles is larger than the scattering attenuation. When the wavelength of the radio wave is similar to the geometric size of the rain particles, rain particle resonance will occur, maximum attenuation will be produced. The higher the wireless frequency and the shorter the wavelength, the greater the impact of rain attenuation.

The estimating module 102 is configured to estimate rain attenuation according to a preset rainfall estimation model and a preset rainfall monitoring system when the weather is bad.

The rainfall estimation model and the rainfall monitoring system are preset. The estimating module 102 calculates the rain attenuation according to formula one, formula two and formula three:

wherein the formula one is:

g_{R}=k(R_{0.01})a(dB/km);

the formula two is:

$$k = \frac{[ kH + k V + ( kH - k V ) cos 2 q cos 2 t ]}{2} ;$$

and

the formula three is:

$$a = \frac{[ kH \times aH + k V \times aV + ( kH \times aH - kH \times aV ) cos 2 q cos 2 t ]}{2 k} ;$$

k and a are frequency correlation coefficients, q is an antenna elevation angle, t is polarization inclination relative to a horizontal plane, kH and aH are frequency correlation coefficients for vertical polarization, and kV and aV are frequency correlation coefficients for horizontal polarization. Wherein, t of circular polarization is equal to 45°, so cos 2t=cos 90°=0.

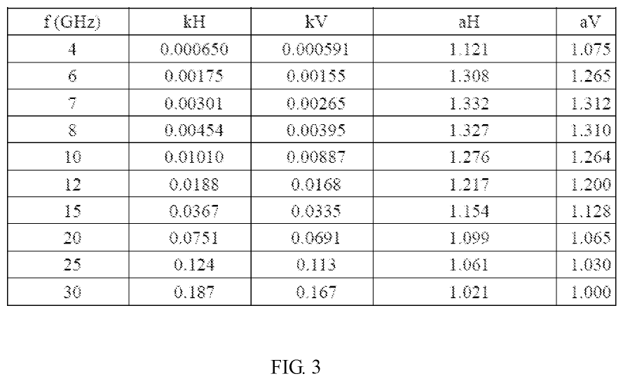

kH, kV, aH, and aV can be taken from a frequency correlation coefficient table (shown in FIG. 3). The amount of data in the frequency correlation coefficient table is small, and the Ku-band (KU-band refers to the low-frequency band of the K-band) only includes three sets of data with frequencies of 10 GHz, 12 GHz and 15 GHz, and the data of other frequencies can be obtained by interpolation. Wherein, the frequency coefficients f and k should adopt logarithmic scale, while the frequency coefficient a should adopt linear scale.

When estimating the rain attenuation, the existing local rainfall intensity data can be used, and the rain area that the area belongs to can also be found from a rain zone division map provided by the International Telecommunication Union—Radio communication Sector (ITU-R) and the Chinese industry standard, and then the rainfall intensity R_{0.01} corresponding to the rain area with a time percentage of 0.01% is found out from the rainfall intensity table.

The variable factor generating module 103 is configured to generate a variable factor when the rain attenuation is not less than a first preset threshold.

Specifically, the variable factor generating module 103 calculates the variable factor according to formula four, wherein the formula four is f\hat{ }d=ka=g_{R}/(R_{0.01}), wherein f\hat{ }d is the variable factor, k and a are the frequency correlation coefficients, R_{0.01} is the rainfall intensity with the time percentage of 0.01%, and g_{R} is the rain attenuation.

5G spectrum is divided into two regions FR1 and FR2 according to the frequency range (FR). The frequency range of FR1 is 450 MHz to 6 GHz, also called Sub6G (below 6 GHz). The frequency range of FR2 is 24 GHz to 52 GHz, most of the electromagnetic wave wavelengths in this spectrum are millimeter-level, so the wave of FR2 is also called mm Wave. At present, C-band is mainly used by operators, with a radio wave wavelength of about 6 cm˜8.6 cm, which is quite different from the radius of raindrops, and is less affected by rainfall, generally less than 2 dB. Therefore, the direct impact of rain attenuation can be ignored for the frequency spectrum below 6 GHz. However, the wavelength of radio waves in the high-frequency 28 Ghz frequency band of FR2 is about 1 cm, and is not easy to penetrate dark clouds and rain. The impact of rainfall on the absorption attenuation and scattering attenuation of radio waves will be more obvious, and the maximum of the absorption attenuation and scattering attenuation can reach 20 dB, especially for the high-frequency microwave transmission, the higher the frequency and the shorter the wavelength, the greater the impact. Therefore, the user experience will be worse, so using this principle, in the embodiment, the first preset threshold is set to 5 dB, and when the rain attenuation is not less than 5 dB, a variable factor is generated to trigger the preset frequency hopping algorithm to adjust the uplink frequency. In other embodiments, developers may set the first preset threshold to other values according to actual needs.

The adjusting module 104 is configured to adjust an uplink frequency according to a preset frequency hopping algorithm when the variable factor exists, specially:

When the rain attenuation is equal to a first preset threshold, the adjusting module 104 adjusts the uplink frequency to a first frequency; when the rain attenuation is greater than the first preset threshold and not greater than a second preset threshold, the adjusting module 104 adjusts the uplink frequency to a second frequency; when the rain attenuation is greater than the second preset threshold and not greater than a third preset threshold, the adjusting module 104 adjusts the uplink frequency to a third frequency; when the rain attenuation is greater than the third preset threshold and not greater than a fourth preset threshold, the adjusting module 104 adjusts the uplink frequency to a fourth frequency; and when the rain attenuation is greater than the fourth preset threshold, the adjusting module 104 adjusts the uplink frequency to a fifth frequency.

In the embodiment, the preset frequency hopping algorithm is divided into 5 situations:

Situation 1: The attenuation g_{R} is 5 dB;

Situation 2: Attenuation 5 dB<g_{R}<=10 dB;

Situation 3: Attenuation 10 dB<g_{R}<=15 dB;

Situation 4: Attenuation 15 dB<g_{R}<=20 dB;

Situation 5: Attenuation g_{R}>20 dB.

The first frequency, the second frequency, the third frequency, the fourth frequency and the fifth frequency are set according to needs, and are not limited in this embodiment.

For example, when the variable factor exists, the frequency hopping algorithm is trigged: when the attenuation g_{R} is 5 dB, FR2 frequency hops to 30 GHz; when the attenuation 5 dB≤g_{R}<=10 dB, FR2 frequency hops to 25 GHz; when the attenuation 10 dB<g_{R}<=15 dB, FR2 frequency hops to 20 GHz; when the attenuation 15 dB≤g_{R}<=20 dB FR2 frequency hops to 15 GHz; when the attenuation g_{R}>20 dB FR2 frequency hops to 10 GHz.

In the embodiment, when the weather is bad, the rain attenuation is estimated according to the rainfall estimation model and the rainfall monitoring system; and the variable factor is generated according to the rain attenuation; when the variable factor exists, the uplink frequency is adjusted according to the preset frequency hopping algorithm. In this way, the margin of the rain attenuation can be considered in planning of 5G wireless network, which ensures that uplink control signals can be reliably received by the base station, and user equipment can receive data better, more efficiently, and more reliably data.

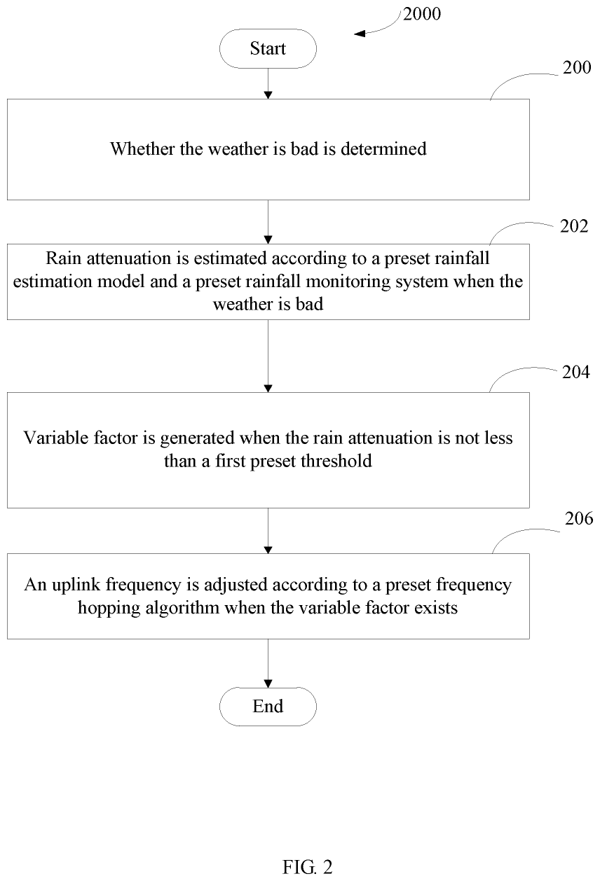

FIG. 2 illustrates a flowchart presented in accordance with an embodiment of an uplink-frequency hopping method 2000. Each block shown in FIG. 2 represents one or more processes, methods, or subroutines, carried out in the exemplary method 2000. Additionally, the illustrated order of blocks is by example only and the order of the blocks can be changed. The method 2000 can begin at block 200.

At block 200, whether the weather is bad is determined.

Specially, determining whether there is at least one of heavy rain, heavy fog, and weather guided wave in current weather condition is determined, if so, then that the current weather condition is bad is determined.

Bad weather will affect wireless communication, so 5G wireless networks will also be affected. Bad weather includes: heavy rain, heavy fog, and weather guided waves. The interference of such bad weather on wireless communication is called rain attenuation. In the planning of 5G wireless network, the margin of the rain attenuation, that is, the attenuation caused by radio waves entering the rain layer, will be considered. According to the actual measurement and statistics, the absorption attenuation of rain particles is larger than the scattering attenuation. When the wavelength of the radio wave is similar to the geometric size of the rain particles, rain particle resonance will occur, maximum attenuation will be produced. The higher the wireless frequency and the shorter the wavelength, the greater the impact of rain attenuation.

At block 202, rain attenuation is estimated according to a preset rainfall estimation model and a preset rainfall monitoring system when the weather is bad. The rainfall estimation model and the rainfall monitoring system are preset.

The rain attenuation is calculated according to formula one, formula two and formula three:

wherein the formula one is:

g_{R}=k(R_{0.01})a(dB/km);

the formula two is:

$$k = \frac{[ kH + k V + ( kH - k V ) cos 2 q cos 2 t ]}{2} ;$$

and

the formula three is:

$$a = \frac{[ kH \times aH + k V \times aV + ( kH \times aH - kH \times aV ) cos 2 q cos 2 t ]}{2 k} ;$$

k and a are frequency correlation coefficients, q is an antenna elevation angle, t is polarization inclination relative to a horizontal plane, kH and aH are frequency correlation coefficients for vertical polarization, and kV and aV are frequency correlation coefficients for horizontal polarization. Wherein, t of circular polarization is equal to 45°, so cos 2t=cos 90°=0.

KH, kV, aH, and aV can be taken from a frequency correlation coefficient table (shown in FIG. 3). The amount of data in the frequency correlation coefficient table is small, and the Ku-band (KU-band refers to the low-frequency band of the K-band) only includes three sets of data with frequencies of 10 GHz, 12 GHz and 15 GHz, and the data of other frequencies can be obtained by interpolation. Wherein, the frequency coefficients f and k should adopt logarithmic scale, while the frequency coefficient a should adopt linear scale.

When estimating the rain attenuation, the existing local rainfall intensity data can be used, and the rain area that the area belongs to can also be found from a rain zone division map provided by the International Telecommunication Union—Radio communication Sector (ITU-R) and the Chinese industry standard, and then the rainfall intensity R_{0.01} corresponding to the rain area with a time percentage of 0.01% is found out from the rainfall intensity table.

At block 204, a variable factor is generated when the rain attenuation is not less than a first preset threshold.

Specifically, the variable factor is calculated according to formula four, wherein the formula four is f\hat{ }d=ka=g_{R}/(R_{0.01}), wherein f\hat{ }d is the variable factor, k and a are the frequency correlation coefficients, R_{0.01} is the rainfall intensity with the time percentage of 0.01%, and g_{R} is the rain attenuation.

5G spectrum is divided into two regions FR1 and FR2 according to the frequency range (FR). The frequency range of FR1 is 450 MHz to 6 GHz, also called Sub6G (below 6 GHz). The frequency range of FR2 is 24 GHz to 52 GHz, most of the electromagnetic wave wavelengths in this spectrum are millimeter-level, so the wave of FR2 is also called mmWave. At present, C-band is mainly used by operators, with a radio wave wavelength of about 6 cm˜8.6 cm, which is quite different from the radius of raindrops, and is less affected by rainfall, generally less than 2 dB. Therefore, the direct impact of rain attenuation can be ignored for the frequency spectrum below 6 GHz. However, the wavelength of radio waves in the high-frequency 28 Ghz frequency band of FR2 is about 1 cm, and is not easy to penetrate dark clouds and rain. The impact of rainfall on the absorption attenuation and scattering attenuation of radio waves will be more obvious, and the maximum of the absorption attenuation and scattering attenuation can reach 20 dB, especially for the high-frequency microwave transmission, the higher the frequency and the shorter the wavelength, the greater the impact. Therefore, the user experience will be worse, so using this principle, in the embodiment, the first preset threshold is set to 5 dB, and when the rain attenuation is not less than 5 dB, a variable factor is generated to trigger the preset frequency hopping algorithm to adjust the uplink frequency. In other embodiments, developers may set the first preset threshold to other values according to actual needs.

At block 206, an uplink frequency is adjusted according to a preset frequency hopping algorithm when the variable factor exists, specially:

when the rain attenuation is equal to a first preset threshold, adjusting the uplink frequency to a first frequency; when the rain attenuation is greater than the first preset threshold and not greater than a second preset threshold, adjusting the uplink frequency to a second frequency; when the rain attenuation is greater than the second preset threshold and not greater than a third preset threshold, adjusting the uplink frequency to a third frequency; when the rain attenuation is greater than the third preset threshold and not greater than a fourth preset threshold, adjusting the uplink frequency to a fourth frequency; and when the rain attenuation is greater than the fourth preset threshold, adjusting the uplink frequency to a fifth frequency.

In the embodiment, the preset frequency hopping algorithm is divided into 5 situations:

Situation 1: The attenuation g_{R} is 5 dB;

Situation 2: Attenuation 5 dB≤g_{R}<=10 dB;

Situation 3: Attenuation 10 dB<g_{R}<=15 dB;

Situation 4: Attenuation 15 dB≤g_{R}<=20 dB;

Situation 5: Attenuation g_{R}>20 dB.

The first frequency, the second frequency, the third frequency, the fourth frequency and the fifth frequency are set according to needs, and are not limited in this embodiment.

For example, when the variable factor exists, the frequency hopping algorithm is trigged: when the attenuation g_{R} is 5 dB, FR2 frequency hops to 30 GHz; when the attenuation 5 dB<g_{R}<=10 dB, FR2 frequency hops to 25 GHz; when the attenuation 10 dB<g_{R}<=15 dB, FR2 frequency hops to 20 GHz; when the attenuation 15 dB<g_{R}<=20 dB, FR2 frequency hops to 15 GHz; when the attenuation g_{R}>20 dB FR2 frequency hops to 10 GHz.

In the embodiment, when the weather is bad, the rain attenuation is estimated according to the rainfall estimation model and the rainfall monitoring system; and the variable factor is generated according to the rain attenuation; when the variable factor exists, the uplink frequency is adjusted according to the preset frequency hopping algorithm. In this way, the margin of the rain attenuation can be considered in planning of 5G wireless network, which ensures that uplink control signals can be reliably received by the base station, and user equipment can receive data better, more efficiently, and more reliably data.

The embodiments shown and described above are only examples. Many details are often found in the art such as the other features of method for video compression by data processing. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An uplink-frequency hopping method, the method comprising:
determining whether the weather is bad;
when the weather is determined to be bad, estimating rain attenuation according to a preset rainfall estimation model and a preset rainfall monitoring system;
when the rain attenuation is estimated to be not less than a first preset threshold, generating a variable factor; and
when the variable factor exists, adjusting an uplink frequency according to a preset frequency hopping algorithm.

2. The uplink-frequency hopping method according to claim 1, wherein estimating rain attenuation according to the preset rainfall estimation model and the preset rainfall monitoring system comprises:
calculating the rain attenuation according to formula one, formula two and formula three,
wherein the formula one is:
g_{R}=k(R_{0.01})a(dB/km);
the formula two is:
$$k = \frac{[ kH + k V + ( kH - k V ) cos 2 q cos 2 t ]}{2} ;$$
and
the formula three is:
$$a = \frac{[ kH \times aH + k V \times aV + ( kH \times aH - kH \times aV ) cos 2 q cos 2 t ]}{2 k} ;$$
wherein g_{R} is the rain attenuation, R_{0.01} is rainfall intensity with a time percentage of 0.01%,
k and a are frequency correlation coefficients, q is an antenna elevation angle, t is polarization inclination relative to a horizontal plane, kH and aH are frequency correlation coefficients for vertical polarization, and kV and aV are frequency correlation coefficients for horizontal polarization.

3. The uplink-frequency hopping method according to claim 2, the variable factor is generated by calculating according to formula four, the formula four being:
f\hat{ }d=ka=g_{R}/(R_{0.01})
wherein f\hat{ }d is the variable factor.

4. The uplink-frequency hopping method according to claim 1, wherein determining whether the weather is bad comprises:
if there is at least one of heavy rain, heavy fog, and weather guided wave in current weather conditions, determining that the weather condition is bad.

5. The uplink-frequency hopping method according to claim 1, wherein adjusting the uplink frequency according to the preset frequency hopping algorithm comprises:
when the rain attenuation is equal to a first preset threshold, adjusting the uplink frequency to a first frequency;
when the rain attenuation is greater than the first preset threshold and not greater than a second preset threshold, adjusting the uplink frequency to a second frequency;
when the rain attenuation is greater than the second preset threshold and not greater than a third preset threshold, adjusting the uplink frequency to a third frequency;
when the rain attenuation is greater than the third preset threshold and not greater than a fourth preset threshold, adjusting the uplink frequency to a fourth frequency; and
when the rain attenuation is greater than the fourth preset threshold, adjusting the uplink frequency to a fifth frequency.

6. An uplink-frequency hopping device, the device comprising:
at least one processor;
a storage unit; and
one or more programs that are stored in the storage unit and executed by the at least one processor, the one or more programs comprising instructions for:
determining whether the weather is bad;
when the weather is bad, estimating rain attenuation according to a preset rainfall estimation model and a preset rainfall monitoring system;
when the rain attenuation is estimated to be not less than a first preset threshold, generating a variable factor; and
when the variable factor exists, adjusting an uplink frequency according to a preset frequency hopping algorithm.

7. The uplink-frequency hopping method according to claim 6, wherein estimating rain attenuation according to the preset rainfall estimation model and the preset rainfall monitoring system comprises:
calculating the rain attenuation according to formula one, formula two and formula three:
wherein the formula one is:
g_{R}=k(R_{0.01})a(dB/km);
the formula two is:
$$k = \frac{[ kH + k V + ( kH - k V ) cos 2 q cos 2 t ]}{2} ;$$
and
the formula three is:
$$a = \frac{[ kH \times aH + k V \times aV + ( kH \times aH - kH \times aV ) cos 2 q cos 2 t ]}{2 k} ;$$
wherein g_{R} is the rain attenuation, R_{0.01} is rainfall intensity with a time percentage of 0.01%,
k and a are frequency correlation coefficients, q is an antenna elevation angle, t is polarization inclination relative to a horizontal plane, kH and aH are frequency correlation coefficients for vertical polarization, and kV and aV are frequency correlation coefficients for horizontal polarization.

8. The uplink-frequency hopping device according to claim 7, the variable factor is generated by calculating according to formula four, the formula four being:
f\hat{ }d=ka=g_{R}/(R_{0.01});
wherein f\hat{ }d is the variable factor.

9. The uplink-frequency hopping device according to claim 6, wherein the step of determining whether the weather is bad comprises:
if there is at least one of heavy rain, heavy fog, and weather guided wave in current weather conditions, determining that the weather condition is bad.

10. The uplink-frequency hopping device according to claim 6, wherein when the variable factor exists, adjusting the uplink frequency according to the preset frequency hopping algorithm comprises:
when the rain attenuation is equal to a first preset threshold, adjusting the uplink frequency to a first frequency;
when the rain attenuation is greater than the first preset threshold and not greater than a second preset threshold, adjusting the uplink frequency to a second frequency;
when the rain attenuation is greater than the second preset threshold and not greater than a third preset threshold, adjusting the uplink frequency to a third frequency;
when the rain attenuation is greater than the third preset threshold and not greater than a fourth preset threshold, adjusting the uplink frequency to a fourth frequency; and
when the rain attenuation is greater than the fourth preset threshold, adjusting the uplink frequency to a fifth frequency.

11. A non-transitory computer-readable storage medium in which computer programs are stored, and the computer programs being executable by at least one processor to process:
determining whether the weather is bad;
when the weather is bad, estimating rain attenuation according to a preset rainfall estimation model and a preset rainfall monitoring system;
when the rain attenuation is estimated to be not less than a first preset threshold, generating a variable factor; and
when the variable factor exists, adjusting an uplink frequency according to a preset frequency hopping algorithm.
